(19) United States
(12) Patent Application Publication
(10) Pub. No.: US 2013/0210520 A1
(43) Pub. Date: Aug. 15, 2013

(54) STORAGE MEDIUM HAVING STORED THEREIN GAME PROGRAM, GAME APPARATUS, GAME SYSTEM, AND GAME IMAGE GENERATION METHOD

(71) Applicant: Makoto YONEZU, Kyoto-shi (JP)

(72) Inventor: Makoto YONEZU, Kyoto-shi (JP)

(73) Assignee: NINTENDO CO., LTD., Kyoto (JP)

(21) Appl. No.: 13/565,974

(22) Filed: Aug. 3, 2012

(30) Foreign Application Priority Data
Feb. 10, 2012 (JP) 2012-026820

(51) Int. Cl. A63F 13/00; A63F 9/24

(52) U.S. Cl. 463/31; 463/43

(57) ABSTRACT

An example of a game system generates a stereoscopic image for stereoscopic display. The game system places a plate-like first model in a virtual space, the plate-like first model representing a part of a single object that appears in the virtual space. Further, the game system places a plate-like second model behind the first model, the plate-like second model representing at least a part of the object other than the part represented by the first model. The game system generates a stereoscopic image representing the virtual space so as to view the first model and the second model in a superimposed manner from in front of the first and second models.

### CROSS REFERENCE TO RELATED APPLICATION

The disclosure of Japanese Patent Application No. 2012-26820, filed on Feb. 10, 2012, is incorporated herein by reference.

### FIELD

The present specification discloses a storage medium having stored therein a game program that performs stereoscopic display, and a game apparatus, a game system, and a game image generation method that perform stereoscopic display.

### BACKGROUND AND SUMMARY

Conventionally, a game apparatus is proposed that uses a stereoscopic display apparatus (a 3D display) capable of performing stereoscopic display. Such a game apparatus can present an image representing a virtual space, in three dimensions to a user.

Conventionally, however, an object formed in a planar manner in the virtual space cannot be presented in three dimensions to the user.

The present specification discloses a storage medium having stored therein a game program that presents an image representing a three-dimensional space, in three dimensions using a non-conventional technique, and a game apparatus, a game system, and a game processing method that present an image representing a three-dimensional space, in three dimensions using a non-conventional technique.

(1)

An example of a storage medium having stored therein a game program according to the present specification is a computer-readable storage medium having stored therein a game program executable by a computer of a game apparatus for generating a stereoscopic image for stereoscopic display. The game program causes the computer to function as first model placement means, second model placement means, and image generation means. The first model placement means places at least one plate-like first model in a virtual space, the plate-like first model representing a part of a single object that appears in the virtual space. The second model placement means places a plate-like second model in line with and behind the first model, the plate-like second model representing at least a part of the object other than the part represented by the first model. The image generation mean generates a stereoscopic image representing the virtual space so as to view the first model and the second model in a superimposed manner from in front of the first and second models.

The “first model” may be placed in front of the “second model”. If layers are set in a virtual space, the “first model” may be set on one of the layers, or may not be set on any of the layers. That is, the first model may be a reference model or an additional model in an exemplary embodiment described later.

In addition, “(places a plate-like second model) in line with (and behind the first model)” means that the first model and the second model are placed so as to appear in a superimposed manner at least parts of the models when viewed in the direction of the line of sight in a stereoscopic image.

On the basis of the above configuration (1), two models (a first model and a second model) arranged in a front-rear direction are placed in a virtual space as models representing a single object. Then, a stereoscopic image is generated in which the first and second models are viewed in a superimposed manner. This results in presenting the single object in three dimensions by the two models. The above configuration (1) makes it possible to cause an object, displayed in a planar manner only by one model (not displayed in a sufficiently three-dimensional manner), to be displayed in three dimensions using two models. This makes it possible to present an image representing a virtual space, in three dimensions using a non-conventional technique.

(2)

The second model placement means may place, on a plurality of layers set in line in a front-rear direction in the virtual space, plate-like models such that the second model is one of the plate-like models. In this case, the image generation means generates as the stereoscopic image an image in which the plate-like models placed on the respective layers and the first model are viewed in a superimposed manner.

On the basis of the above configuration (2), a plurality of plate-like models including the second model are placed in a layered manner, and the stereoscopic image is generated in which the plate-like models and the first model are viewed in a superimposed manner. Thus, on the basis of the above configuration (2), the first model is placed in front of the plate-like model (the second model) representing a desired object among the plate-like models placed in a layered manner, whereby it is possible to cause the desired object to be displayed in three dimensions.

(3)

The first model placement means may place the first model between the layer on which the second model is placed and the layer placed immediately in front thereof or immediately therebehind.

On the basis of the above configuration (3), the first model is placed such that there is no layer (other than the layer on which the second model is placed) between the second model and the first model. This maintains the consistency of the front-rear relationships between the first model and the plate-like models placed on the respective layers, which makes it possible to cause an object to be displayed in three dimensions with a natural representation.

(4)

The first model placement means may place, on a plurality of layers set in line in a front-rear direction in the virtual space, plate-like models such that the first model is one of the plate-like models. In this case, the image generation means generates as the stereoscopic image an image in which the plate-like models placed on the respective layers and the second model are viewed in a superimposed manner.

On the basis of the above configuration (4), a plurality of plate-like models including the first model are placed in a layered manner, and the stereoscopic image is generated in which the plate-like models and the second model are viewed in a superimposed manner. Thus, on the basis of the above configuration (4), the second model is placed behind the plate-like model (the first model) representing a desired object among the plate-like models placed in a layered manner, whereby it is possible to cause the desired object to be displayed in three dimensions.

(5)

The second model placement means may place the second model between the layer on which the first model is placed and the layer placed immediately in front thereof or immediately therebehind.

On the basis of the above configuration (5), the second model is placed such that there is no layer (other than the layer on which the first model is placed) between the first model and the second model. This maintains the consistency of the front-rear relationships between the second model and the plate-like models placed on the respective layers, which makes it possible to cause an object to be displayed in three dimensions with a natural representation.

(6)

The image generation means may generate the stereoscopic image so as to include an image representing the first model and the second model in orthogonal projection.

On the basis of the above configuration (6), the stereoscopic image is generated in which a plurality of images, each represented in a planar manner by one layer, are superimposed on one another in a depth direction. This makes it possible to generate a stereoscopic image in which the positional relationships (the front-rear relationships) between objects placed on different layers appear in three dimensions.

(7)

The image generation means may generate the stereoscopic image in which a direction of a line of sight is generally perpendicular to all the models.

On the basis of the above configuration (7), the stereoscopic image is generated in which the models placed so as to be generally parallel to one another are viewed in a superimposed manner in a direction generally perpendicular to all the models. This makes it possible to generate a stereoscopic image in which the positional relationships (the front-rear relationships) between objects placed at different positions in a front-rear direction appear in three dimensions.

(8)

The image generation means may generate the stereoscopic image such that the part of the object represented by the second model includes an image representing shade.

On the basis of the above configuration (8), display is performed such that shade is drawn on the part of the object represented by the second model behind the first model. The application of shade in such a manner makes it possible to facilitate the viewing of the concavity or convexity of an object, which makes it possible to represent an object having concavity and convex more realistically.

(9)

The image generation means may generate the stereoscopic image such that an image of the part of the object represented by the first model is an image in which an outline other than an outline of the single object is blurred.

On the basis of the above configuration (9), the boundary between the part of the object represented by the first model and the part of the object represented by the second model is made unclear. This makes it possible to smoothly represent the concavity and convexity formed by the first model and the second model. That is, the above configuration (9) makes it possible to enhance the naturalness of the stereoscopic display of an object having continuously-changing concavity and convexity, such as a sphere or a cylinder. This makes it possible to represent the object more realistically.

(10)

The image generation means may perform drawing on the first model using a predetermined image representing the single object, and perform drawing on the second model also using the predetermined image.

On the basis of the above configuration (10), it is not necessary to prepare in advance an image for each of the first model and the second model. This makes it possible to reduce the amount of image data to be prepared.

(11)

The game program may further cause the computer to function as game processing means for performing game processing of performing collision detection between the single object and another object using either one of the first model and the second model.

On the basis of the above configuration (11), the collision detection between the object represented by the first model and the second model and another object is performed using either one of the two models. This makes it possible to simplify the process of the collision detection.

It should be noted that the present specification discloses examples of a game apparatus and a game system that include means equivalent to the means achieved by executing the game program according to the above configurations (1) to (11). The present specification also discloses an example of a game image generation method performed by the above configurations (1) to (11).

The game program, the game apparatus, the game system, and the game image generation method make it possible to present an object, displayed in a planar manner only by one model (not displayed in a sufficiently three-dimensional manner), in three dimensions using a novel technique by representing a single object by two models placed in a front-rear direction.

These and other objects, features, aspects and advantages of the exemplary embodiment will become more apparent from the following detailed description of the exemplary embodiment when taken in conjunction with the accompanying drawings.

### BRIEF DESCRIPTION OF THE DRAWINGS

FIG. 1 is a diagram showing an overview of a non-limiting exemplary embodiment;

FIG. 2 is a diagram showing a non-limiting example of the placement of a reference model and an additional model in another embodiment;

FIG. 3 is a diagram showing a non-limiting example of the method of generating a stereoscopic image;

FIG. 4 is a block diagram showing a non-limiting example of a game system according to the exemplary embodiment;

FIG. 5 is a diagram showing a non-limiting example of data store in a storage section 13 in the exemplary embodiment; and

FIG. 6 is a flow chart showing a non-limiting example of the flow of the processing performed by a control section 12 in the exemplary embodiment.

### DETAILED DESCRIPTION OF NON-LIMITING EXAMPLE EMBODIMENTS

With reference to the drawings, descriptions are given below of a game system and the like according to an exemplary embodiment. The game system according to the exemplary embodiment causes an object, represented in a planar manner in a virtual three-dimensional space (a game space), to be displayed in three dimensions on a stereoscopic display apparatus. It should be noted that, while the object to be displayed in three dimensions (a three-dimensional display target) may be any object, the descriptions are given below taking as an example the case where an earthenware pipe object is displayed in three dimensions. That is, the descriptions are given below taking as an example the case where a central portion of an earthenware pipe drawn in a planar manner is caused to appear to be convex, thereby performing stereoscopic display such that the earthenware pipe appears to be cylindrical.

### 1. Overview of the Exemplary Embodiment

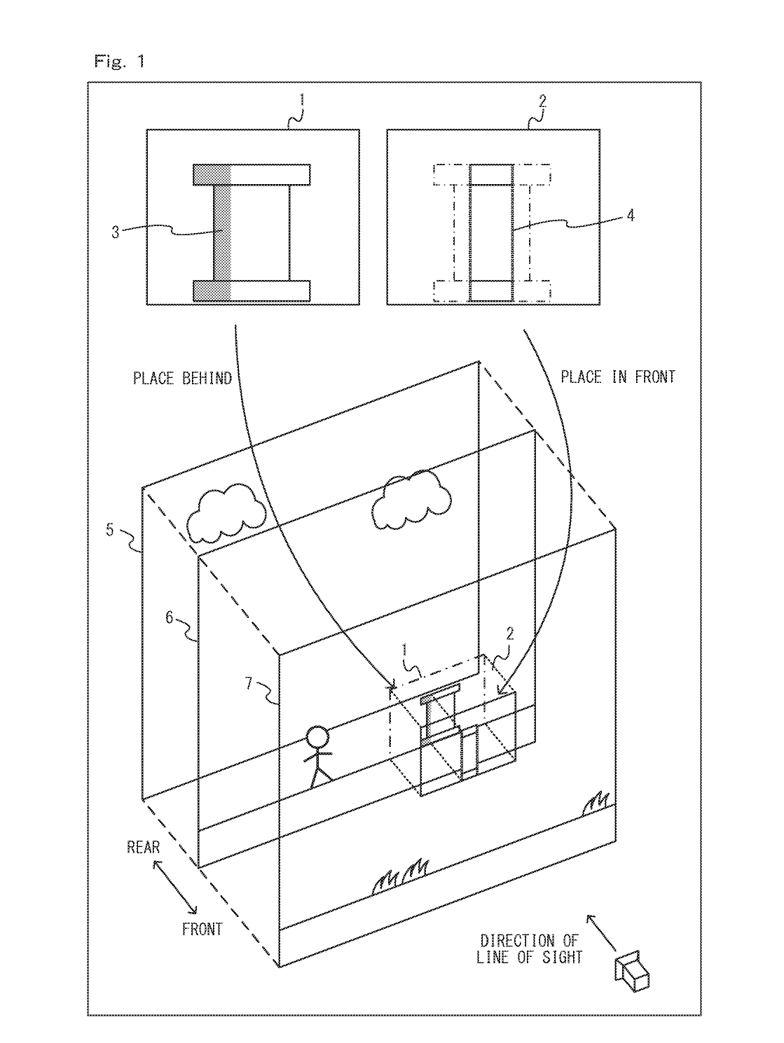

With reference to FIGS. 1 through 3, an overview of the exemplary embodiment is described below. FIG. 1 is a diagram showing an overview of the exemplary embodiment. As shown in FIG. 1, in the exemplary embodiment, a reference model 1 is prepared on which an object (an earthenware pipe) that is a three-dimensional display target is drawn. The reference model 1 represents at least a part of a single object (the entirety of the object in FIG. 1) that is a three-dimensional display target. The reference model 1 has a plate-like shape, and is formed, for example, of a polygon. The term “plate-like” means that the model may be a plane (a flat surface or a curved surface), or may be a structure having a certain thickness.

In the exemplary embodiment, in addition to the reference model 1, an additional model 2 is prepared as another model for representing the three-dimensional display target object (the earthenware pipe). The additional model 2 represents at least a part of the object. The reference model 1 and the additional model 2 represent one object (the earthenware pipe). In the exemplary embodiment, as shown in FIG. 1, the additional model 2 represents a part of the object (it should be noted that, in the illustration on the top right of FIG. 1, the portion of the entire object that is not represented by the additional model 2 is indicated by a dashed-dotted line in order to facilitate understanding). In the exemplary embodiment, the portion represented by the additional model 2 is the portion of the object that is concave or convex relative to the reference model 1 (here, a convex portion; i.e., a central portion of the earthenware pipe). The additional model 2 has a plate-like (planar) shape, and is formed, for example, of a polygon.

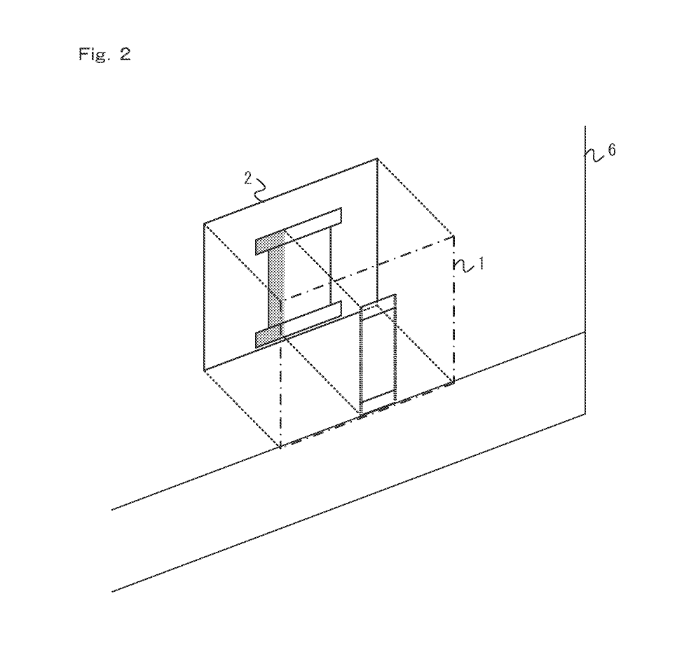

The additional model 2 is placed in line with and in front of or behind the reference model 1. In the exemplary embodiment, the additional model 2 is placed in front of the reference model 1 (see the illustration on the bottom of FIG. 1). Alternatively, in another embodiment, the reference model 1 may be placed in front of the additional model 2 (see FIG. 2). It should be noted that, here, the front/rear relationship is defined such that, in the direction of the line of sight of a virtual camera for generating a stereoscopic image, the side closer to the virtual camera is the front side, and the side further from the virtual camera is the rear side (see arrows shown in FIG. 1). The reference model 1 and the additional model 2 are arranged such that either one of the models is placed at a position closer to the viewpoint of the virtual camera, and the other model is placed at a position further from the viewpoint than that of the closer model.

With the models 1 and 2 placed in front and behind as described above, a stereoscopic image is generated that represents a virtual space so as to view the models 1 and 2 in a superimposed manner from in front of the models 1 and 2 (view the models 1 and 2 from a position where the models 1 and 2 appear to be superimposed one on the other). In the exemplary embodiment, a stereoscopic image is generated that represents the virtual space where the reference model 1 is placed behind (at a position further than that of) the additional model 2. This results in the stereoscopic image in which an image of the portion of the object drawn on the additional model 2 appears to protrude to the closer side from an image of the object drawn on the reference model 1.

As described above, the exemplary embodiment makes it possible to cause an object, represented in a planar manner by a plate-like model, to appear in three dimensions. In the example of the earthenware pipe in the exemplary embodiment, the central portion of the earthenware pipe appears to protrude, which makes it possible to cause the earthenware pipe to appear to be cylindrical. Further, the exemplary embodiment makes it possible to cause an object, represented in a planar manner by the reference model 1, to appear in three dimensions by a simple method such as adding the additional model 2. This makes it possible to present the object in three dimensions to a user without applying a heavy processing load to an information processing apparatus. For example, the reference model 1 and the additional model 2 may each be formed of one flat surface (polygon), in which case it is possible to present the object in three dimensions by a simpler process.

(1) Images Drawn on Models

The models 1 and 2 represent a single object that is a three-dimensional display target. That is, images of the same one object are drawn on the models 1 and 2. Specifically, between the reference model 1 and the additional model 2, the model in front represents a part of the single object, and the model behind represents at least a part of the object other than the part represented by the model in front. More specifically, a part of one surface of the object (a lateral surface of the cylindrical earthenware pipe in FIG. 1) is drawn on the model in front, and a part of the one surface other than the part drawn on the model in front is drawn on the model behind. Thus, the image drawn on the reference model 1 (referred to as a “reference image”) and the image drawn on the additional model 2 (referred to as an “additional image”) are generated so as to represent the entirety of the single object when the two images are superimposed one on the other.

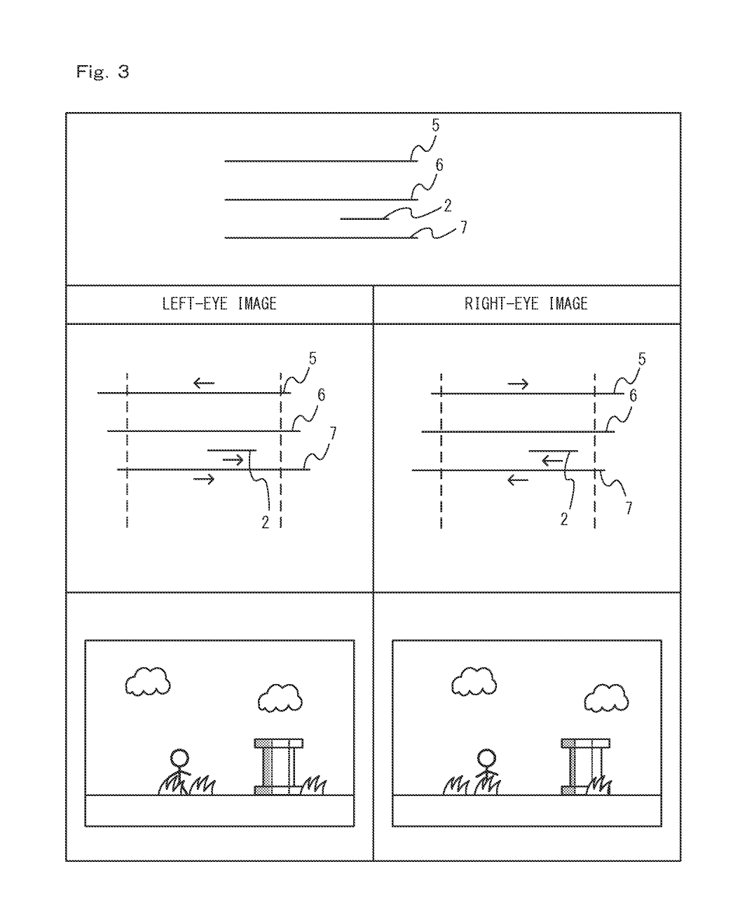

It should be noted that, although described in detail later, in the exemplary embodiment, when the stereoscopic image is generated, the positional relationship between the two models, namely 1 and 2, when viewed in the direction of the line of sight shifts to the left and right (see FIG. 3). Thus, the reference image and the additional image may be generated so as to overlap each other in the left-right direction at a boundary portion (a boundary 4 shown in FIG. 1) between the reference image and the additional image. It should be noted that the boundary portion refers to the boundary between the reference image and the additional image when viewed in the direction of the line of sight. In the exemplary embodiment, as shown in FIG. 1, the reference image representing the entirety of the object is drawn on the reference model 1. Thus, it can be said that the reference image and the additional image are generated so as to overlap each other in the left-right direction.

In addition, the image drawn on, between the models 1 and 2, the model placed in front (here, the additional model 2) may be any image so long as it represents a part of the three-dimensional display target object, and the position of the image and the number of the images are optional. For example, in a manner opposite to the additional image shown in FIG. 1, an additional image representing the left and right end portions of the object may be drawn on the additional model 2. In this case, the object (the earthenware pipe) appears such that the left and right end portions of the object protrude, and the central portion of the object is depressed. Further, for example, if the three-dimensional display target is an object having concavity and convexity, an additional image representing a plurality of convex portions of the object may be drawn on the additional model 2. This makes it possible to cause the concavity and convexity of the object to appear in three dimensions.

In addition, the image drawn on, between the models 1 and 2, the model in front may be an image in which an outline other than the outline of the display target object (an outline different from the outline of the display target object) is blurred. Among outlines included in the additional image, an outline 4, which is not the outline of the object (in other words, the boundary between the additional image and the reference image when viewed in the direction of the line of sight), is generated in a blurred manner (see FIG. 1; it should be noted that, in FIG. 1, the state of the outline 4 being blurred is represented by a dotted line). The image having the blurred outline may be generated by any method. The image may be generated, for example, by a method of mixing the colors of both sides of the outline together in a portion near the outline, or a method of making semitransparent a portion near the outline.

If, as described above, an image is used in which the outline of the boundary portion between the reference image and the additional image is blurred, the boundary between the two images is made unclear, which causes the concavity and convexity formed by the reference model 1 and the additional model 2 to appear to be smooth. For example, the earthenware pipe shown in FIG. 1 appears to be cylindrical. The image in which the outline is blurred as described above is thus used, whereby it is possible to enhance the naturalness of the stereoscopic display of an object having continuously-changing concavity and convexity. This makes it possible to represent the object more realistically.

In addition, the image drawn on, between the models 1 and 2, the model behind may include an image representing shade. It should be noted that the image representing shade is drawn in a portion of the object other than the portion represented by the model in front. In the exemplary embodiment, in the portion represented by the reference model 1, a part of the portion not overlapping the portion represented by the additional model 2 (more specifically, a part near the left end of the earthenware pipe) is an image representing shade 3. The image representing shade is thus drawn, whereby it is possible to facilitate the viewing of the concavity and convexity of the object. Further, shade may be drawn on the model behind with such gradations that the closer to the boundary between the additional image and the reference image, the lighter the shade. This causes the concavity and convexity formed by the reference model 1 and the additional model 2 to appear to be smooth, which makes it possible to enhance the naturalness of the stereoscopic display of an object having continuously-changing concavity and convexity.

(2) Method of Generating Reference Image and Additional Image

The method of generating the reference image and the additional image may be any method. In the exemplary embodiment, the reference image (a reference model texture described later) and the additional image (an additional model texture described later) are generated using a single image prepared in advance (an original texture described later). That is, in the exemplary embodiment, one (one type of) image is prepared for a single object that is a display target. This eliminates the need to prepare two images, namely the reference image and the additional image, in advance. This makes it possible to reduce the amount of image data to be prepared, which makes it possible to reduce the work of developers such as the preparation (creation) of images. Specifically, in the exemplary embodiment, data of an image representing the entirety of the object (the earthenware pipe) is prepared in advance as an original texture. Then, the original texture is used as it is as a texture to be drawn on the reference model 1 (a reference model texture). Further, a texture to be drawn on the additional model 2 (an additional model texture) is generated by processing the original texture. That is, from the image of the original texture representing the entirety of the object, the additional model texture is generated that represents an image subjected to the process of making transparent the portion other than that corresponding to the additional image. It should be noted that the exemplary embodiment employs as the additional model texture an image subjected to the process of blurring the outline of the boundary portion between the reference image and the additional image, in addition to the above process. It should be noted that, in another embodiment, the reference model texture and the additional model texture may be (separately) prepared in advance.

(3) Display Target Object

In the exemplary embodiment, the display target object is a “single object”. That is, the two images, namely the reference image and the additional image, represent a single object. To cause the display target object to appear to be a “single object”, the reference image and the additional image may be set as follows. For example, the same image may be set in the portions of the reference image and the additional image that overlap each other (the overlapping portions). Alternatively, for example, the reference image and the additional image may be set such that the boundary (the outline) between the reference image and the additional image is not recognized when the reference image and the additional image are superimposed one on the other. Yet alternatively, for example, the single object may be represented by the reference image and the additional image generated from a single image. On the basis of the above, it can be said that the object represented by both images (the reference image and the additional image) is a single object. As well as the above, in the case of a single object, it is possible to perform the process of collision detection (described in detail later) between the object and another object using only either one of the models 1 and 2. Thus, if the process of collision detection as described above is performed using either one of the models 1 and 2, it can be said that the object formed of the models 1 and 2 is a single object.

In addition, the concavity and convexity of the display target object may be formed in any manner. That is, in the exemplary embodiment, the object is displayed in three dimensions so as to have concavity and convexity in the left-right direction by way of example. Alternatively, in another embodiment, the object may be displayed in three dimensions so as to have concavity and convexity in the up-down direction. For example, if the reference model 1 and the additional model 2 shown in FIG. 1 are rotated 90 degrees when placed, the object (the earthenware pipe) is displayed in three dimensions so as to have concavity and convexity in the up-down direction. As described above, the exemplary embodiment makes it possible to cause an object having concavity and convexity in any direction to be displayed in three dimensions, by a simple process such as additionally placing the additional model 2.

(4) Placement of Models

As well as the reference model 1 and the additional model 2, models representing other objects may be placed in the virtual space. If other models are placed, the other models may be any types of models (may not need to be plate-like). In the exemplary embodiment, plate-like models are placed in the virtual space in a layered manner. That is, in the exemplary embodiment, as shown in FIG. 1, a plurality of layers 5 through 7 are set (three layers are set in FIG. 1, but any number of layers may be set) in line in the front-rear direction in the virtual space. Then, the plate-like models representing other objects (clouds, grass, a human-shaped character, and the like in FIG. 1) are placed on (any of) the plurality of layers 5 through 7. Hereinafter, a plate-like model placed on a layer is referred to as a “layer model”. One or more plate-like layer models are placed on one layer. In this case, as the stereoscopic image, an image is generated in which the plate-like models (including the reference model 1) placed on the layers 5 through 7 and the additional model 2 are viewed in a superimposed manner. Thus, in the exemplary embodiment, the stereoscopic image is generated such that, although the objects other than the display target object (the earthenware pipe) are planar, the positional relationships (the front-rear relationships) between the objects placed on different layers appear in three dimensions. Further, the display target object itself is displayed in three dimensions by the additional model 2. That is, in the exemplary embodiment, the additional model 2 is placed in front of or behind the plate-like model (the reference model 1) representing a desired object among the objects represented by the plurality of layer models, whereby it is possible to cause the desired object to be displayed in three dimensions.

The layer models may be flat surfaces, or may be curved surfaces. The layer models are each formed, for example, of a polygon. A layer model may be generated and placed for one object, or may be generated and placed for a plurality of objects (for example, a plurality of clouds). It should be noted that, in the exemplary embodiment, the reference model 1 is placed on one of the layers (the layer 6 in FIG. 1). Thus, it can be said that the reference model 1 is one of the layer models.

In addition, the layers 5 through 7 (the layer models placed on the layers) are placed so as to be generally parallel to one another in FIG. 1, but may not be placed so as to be parallel to one another. For example, some of a plurality of layers may be placed so as to be inclined relative to the other layers.

The reference model 1 and the additional model 2 are placed so as to be separate from each other in front and behind. Further, the distance between the reference model 1 and the additional model 2 is any distance, and may be appropriately determined in accordance with the degree of concavity and convexity of the three-dimensional display target object. If, however, layer models (including the reference model 1) are placed on a plurality of layers as in the exemplary embodiment, the additional model 2 may be placed between the layers. That is, the additional model 2 may be placed between the reference model 1 and the plate-like model (the layer model) placed immediately in front thereof or immediately therebehind. Specifically, in the exemplary embodiment, as shown in FIG. 1, the additional model 2 is placed between the reference model 1 and the layer model placed immediately in front thereof (the layer model placed on the layer 7).

As described above, if the additional model 2 is placed between the reference model 1 and the layer model placed immediately in front thereof or immediately therebehind, it is possible to cause the display target to be displayed in three dimensions so as to be consistent with the front-rear relationships between the layers. For example, in the exemplary embodiment, the earthenware pipe placed on the layer 6, which is placed in the middle of the layers, is displayed in three dimensions, but the convex portion of the earthenware pipe (the portion represented by the additional model 2) is placed behind the layer 7 placed in front of the layer 6. This makes it possible to cause an object to be displayed in three dimensions with such a natural representation as not to conflict with the front-rear relationships between the layers.

It should be noted that, in another embodiment, the additional model 2 may be placed behind the reference model 1. FIG. 2 is a diagram showing the placement of the reference model and the additional model in another embodiment. As shown in FIG. 2, if the reference model 1 is placed on the layer 6, the additional model 2 may be placed behind the layer 6. More specifically, the additional model 2 may be placed between the reference model 1 and the layer model placed immediately therebehind (the layer model placed on the layer 5). It should be noted that, in this case, the reference model 1 is placed in front, and the additional model 2 is placed behind. Thus, in the three-dimensional display target object, the portions represented by the models 1 and 2 are different from those in the exemplary embodiment. That is, the reference model 1 in front represents a part of the object, and the additional model 2 behind represents at least a part of the object other than the part represented by the reference model 1 (represents the entirety of the object in FIG. 2). If the reference model 1 is placed on a layer, the placement of the additional model 2 in front of the reference model 1 makes it possible to represent the object so as to be convex from the layer; and the placement of the additional model 2 behind the reference model 1 makes it possible to represent the object so as to be concave from the layer.

In addition, in another embodiment, models placed in the virtual space other than the reference model 1 and the additional model 2 may be formed in three dimensions. That is, the other models may have lengths in the up-down direction, the left-right direction, and the front-rear direction. For example, a terrain model formed in three dimensions may be placed in the virtual space. That is, it is possible to use the technique of the exemplary embodiment for a plate-like model (for example, a billboard) placed on the terrain model. That is, the reference model 1 and the additional model 2 may be placed on the terrain model formed in three dimensions, thereby displaying a single object in three dimensions by the reference model 1 and the additional model 2.

In addition, in another embodiment, an additional model may be set for each of a plurality of objects. This makes it possible to cause the plurality of objects themselves to be displayed in three dimensions. Further, in this case, the distance between the reference model and the additional model corresponding thereto may be set to vary depending on the object. This makes it possible to vary the degree of protrusion (or depression) in stereoscopic display depending on the object, which makes it possible to vary the degree of concavity and convexity depending on the object. In other words, it is possible to realistically represent the concavity and convexity of even a plurality of objects that vary in the degree of concavity and convexity.

In addition, in another embodiment, the distance between the reference model 1 and the additional model 2 may change under a predetermined condition. This makes it possible to change the stereoscopic effect of the three-dimensional display target object (the degree of concavity and convexity of the object). The distance may change in accordance with, for example, the satisfaction of a predetermined condition in a game, or a predetermined instruction given by a user. Alternatively, instead of the change in the distance as described above, the amount of shift of the additional model 2 relative to the reference model 1 in the left-right direction may be changed in the process described later of generating a stereoscopic image. This also makes it possible to change the stereoscopic effect of the three-dimensional display target object.

It should be noted that at least one additional model may be placed, and in another embodiment, a plurality of additional models may be placed. That is, a single object may be represented by placing three or more models, namely a reference model and additional models, in line in front and behind (on three or more layers). The use of the reference model and the plurality of additional models placed on the three (or more) layers makes it possible to represent the concavity and convexity of the object with increased smoothness. It should be noted that, if a reference model and additional models are placed in line on three or more layers, all the additional models may be placed in front of the reference model, or all the additional models may be placed behind the reference model. Alternatively, some of the additional models may be placed in front of the reference model, and the other additional models may be placed behind the reference model. It should be noted that, if a reference model and additional models are placed in line on three or more layers, the models other than the rearmost model placed furthest behind represent a part of the display target object. Further, the rearmost model represents, in the display target object, at least a portion not represented by the models placed in front of the rearmost model.

(5) Generation of Stereoscopic Image

When the reference model 1 and the additional model 2 are placed, a stereoscopic image is generated that represents the virtual space including the models 1 and 2. The stereoscopic image is a stereoscopically viewable image, and more specifically, is an image presented in three dimensions to a viewer (a user) when displayed on a display apparatus capable of performing stereoscopic display (a stereoscopic display apparatus). The stereoscopic image includes a right-eye image to be viewed by the user with the right eye and a left-eye image to be viewed by the user with the left eye. The stereoscopic image is generated such that the positional relationships between the models (the objects) placed in the virtual space at different positions (on different layers) in the front-rear direction differ between the left-eye image and the right-eye image. Specifically, the left-eye image is an image in which the models in front of a predetermined reference position are shifted to the right in accordance with the respective distances from the predetermined reference position in the front-rear direction, and the models behind the predetermined reference position are shifted to the left in accordance with the respective distances. Further, the right-eye image is an image in which the models in front of the predetermined reference position are shifted to the left in accordance with the respective distances, and the models behind the predetermined reference position are shifted to the right in accordance with the respective distances. It should be noted that the predetermined reference position is the position where (if a model is placed at the predetermined reference position) the model is displayed at the same position in the right-eye image and the left-eye image, and the predetermined reference position is, for example, the position of the layer 6 in FIG. 3.

The method of generating the stereoscopic image (the right-eye image and the left-eye image) may be any method, and possible examples of the method include the following. FIG. 3 is a diagram showing an example of the method of generating the stereoscopic image. In a first method shown in FIG. 3, the stereoscopic image is generated by shifting the models in the left-right direction by the amounts of shift based on the respective distances (the distances in the front-rear direction) from the predetermined reference position (the position of the layer 6 in FIG. 3) such that the shifting directions are opposite to each other between the right-eye image and the left-eye image. In the first method, the right-eye image and the left-eye image are generated by superimposing images of all the models, shifted as described above, one on another in a predetermined display range (a range indicated by dotted lines in FIG. 3).

It should be noted that, in the first method, the right-eye image and the left-eye image are generated by performing rendering after shifting the models. Alternatively, in a second method, the right-eye image and the left-eye image may be generated by rendering the layers and the additional models with respect to each layer and each additional model to generate a plurality of images, and combining the plurality of generated images together in a shifting manner.

In addition, as well as the methods described above of shifting the models in the left-right direction, in a third method, the stereoscopic image may be generated by the method of generating a stereoscopic image using two virtual cameras placed at positions different, and directed in directions different, between the right-eye image and the left-eye image.

The generation of the stereoscopic image as described above results in presenting in three dimensions the positional relationships between the models placed in a layered manner. It should be noted that the reference model 1 and the additional model 2 are located at different distances from the viewpoint in the direction of the line of sight (the front-rear direction). Thus, the positional relationship between the reference model 1 and the additional model 2 differs between the left-eye image and the right-eye image (see FIG. 3). In this regard, it is possible to prevent the occurrence of a gap between the reference image and the additional image by, as described above, generating the reference image and the additional image so as to overlap each other in the left-right direction at the boundary portion (the boundary 4 shown in FIG. 1) between the reference image and the additional image.

It should be noted that, as shown in FIG. 3, the stereoscopic image (the right-eye image and the left-eye image) is generated so as to include an image representing the reference model 1 and the additional model 2 in orthogonal projection. An image represented in orthogonal projection refers to an image obtained by projecting the virtual space in orthogonal projection onto a predetermined plane of projection, or an image similar to the obtained image (but obtained not by a method of performing projection in orthogonal projection). It should be noted that, in the first method described above, it is possible to obtain an image represented in orthogonal projection, by projecting all the shifted models in orthogonal projection onto a predetermined plane of projection. Further, in the second method described above, it is possible to obtain an image represented in orthogonal projection, by combining together in a superimposed manner the plurality of images obtained by rendering. Furthermore, in the third method described above, it is possible to obtain an image represented in orthogonal projection, by projecting all the models in orthogonal projection onto a predetermined plane of projection on the basis of the positions of the two virtual cameras.

In addition, the stereoscopic image may be generated such that the direction of the line of sight is generally perpendicular to all the models (see FIG. 1). In the exemplary embodiment, all the layer models (including the reference model 1) and the additional model 2 are placed so as to be generally parallel to one another, and an image of the virtual space viewed in the direction of the line of sight, which is generally perpendicular to all the models, is generated as the stereoscopic image. It should be noted that, in another embodiment, in addition to a plurality of layers perpendicular to the direction of the line of sight, a layer slightly inclined relative to the direction of the line of sight may be set, and a model may be placed on the layer.

(6) Collision Detection

In game processing, collision detection may be performed between the three-dimensional display target object and another object. If collision detection is performed, the three-dimensional display target object is subjected to the collision detection using the reference model 1 and the additional model 2. A specific method of the collision detection may be any method. In the exemplary embodiment, the collision detection is performed using either one of the reference model 1 and the additional model 2. The collision detection is thus performed using either one of the two models, namely 1 and 2, whereby it is possible to simplify the process of the collision detection. It should be noted that, if either one of the two models, namely 1 and 2, represents the entirety of the object as in the exemplary embodiment, the collision detection may be performed using the one of the models. This makes it possible to perform collision detection with increased accuracy even if only one of the models is used.

Specifically, the collision detection between the three-dimensional display target object and another object placed on the same layer as that of the reference model 1 may be performed using the plate-like model of said another object and the reference model 1, or may be performed using the plate-like model of said another object and the additional model 2. In the first case, it is possible to perform the collision detection by comparing the positions of the two models in the virtual space with each other. Further, in the second case, it is possible to perform the collision detection by comparing the positions of the two models in the up-down direction and the left-right direction (without respect to the positions of the two models in the front-rear direction). As described above, collision detection can be performed between models placed at the same position in the front-rear direction (the same depth position), and can also be performed between models placed at different positions in the front-rear direction.

In addition, on the basis of the position of said another object in the front-rear direction, it may be determined which of the reference model 1 and the additional model 2 is to be used for the collision detection. Specifically, with the middle position between the reference model 1 and the additional model 2 in the front-rear direction defined as a reference position, the collision detection between an object placed at a position closer to the additional model 2 (placed in front in FIG. 1) and the three-dimensional display target object may be performed using the additional model 2. Alternatively, the collision detection between an object placed at a position closer to the reference model 1 (placed behind in FIG. 1) on the basis of the reference position and the three-dimensional display target object may be performed using the reference model 1. On the basis of the above, it is possible to perform collision detection without discomfort in the positional relationships in the front-rear direction.

### 2. Specific Configurations and Operations of the Exemplary Embodiment

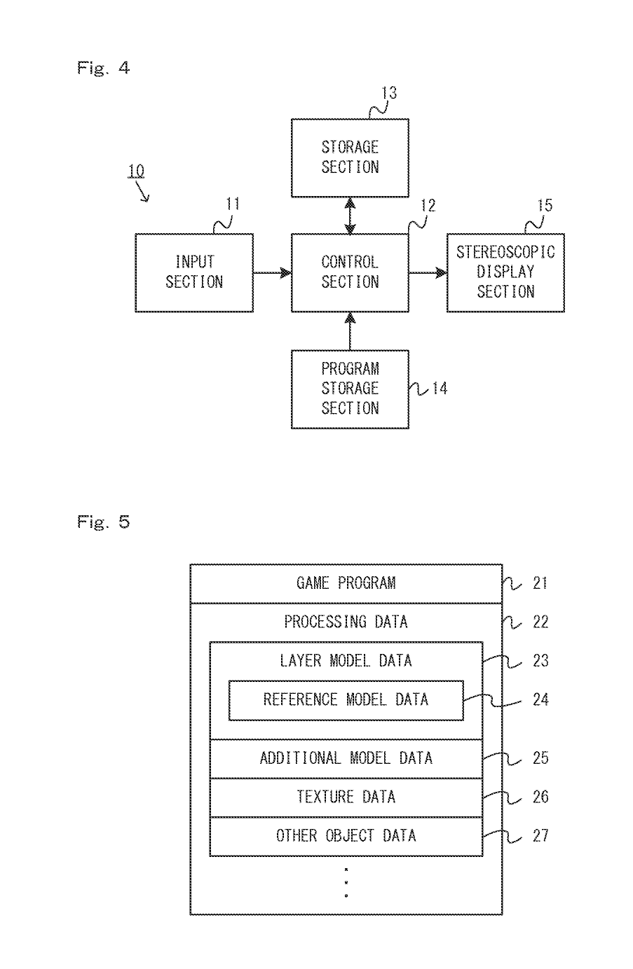

With reference to FIGS. 4 through 6, descriptions are given of specific configurations and operations of the game system and the like according to the exemplary embodiment. FIG. 4 is a block diagram showing an example of the game system (a game apparatus) according to the exemplary embodiment. In FIG. 4, the game system 10 includes an input section 11, a control section 12, a storage section 13, a program storage section 14, and a stereoscopic display section 15. The game system 10 may be a single game apparatus (including a handheld game apparatus) having the above components 11 through 15. Alternatively, the game system 10 may include one or more apparatuses containing: an information processing apparatus (a game apparatus) having the control section 12; and another apparatus.

The input section 11 is an input apparatus that can be operated (subjected to a game operation performed) by the user. The input section 11 may be any input apparatus.

The control section 12 is information processing means (a computer) for performing various types of information processing, and is, for example, a CPU. The control section 12 has the functions of performing as the various types of information processing: the process of placing the models in the virtual space to generate a stereoscopic image representing the virtual space; game processing based on the operation performed on the input section 11 by the user; and the like. The above functions of the control section 12 are achieved, for example, as a result of the CPU executing a predetermined game program.

The storage section 13 stores various data to be used when the control section 12 performs the above information processing. The storage section 13 is, for example, a memory accessible by the CPU (the control section 12).

The program storage section 14 stores a game program. The program storage section 14 may be any storage device (storage medium) accessible by the control section 12. For example, the program storage section 14 may be a storage device provided in the information processing apparatus having the control section 12, or may be a storage medium detachably attached to the information processing apparatus having the control section 12. Alternatively, the program storage section 14 may be a storage device (a server or the like) connected to the control section 12 via a network. The control section 12 (the CPU) may read some or all of the game program to the storage section 13 at appropriate timing, and execute the read game program.

The stereoscopic display section 15 is a stereoscopic display apparatus (a 3D display) capable of performing stereoscopic display. The stereoscopic display section 15 displays a right-eye image and a left-eye image on a screen in a stereoscopically viewable manner. The stereoscopic display section 15 displays the right-eye image and the left-eye image on a single screen in a frame sequential manner or a field sequential manner. The stereoscopic display section 15 may be a 3D display that allows autostereoscopic viewing by a parallax barrier method, a lenticular method, or the like, or may be a 3D display that allows stereoscopic viewing with the user wearing glasses.

FIG. 5 is a diagram showing an example of data stored in the storage section 13 in the exemplary embodiment. As shown in FIG. 5, a memory of the control section 12 stores a game program 21 and processing data 22. It should be noted that the storage section 13 may store, as well as the data shown in FIG. 5, input data acquired from the input section 11, data of an image to be output to the stereoscopic display section 15 and an image used to generate the image to be output, and the like.

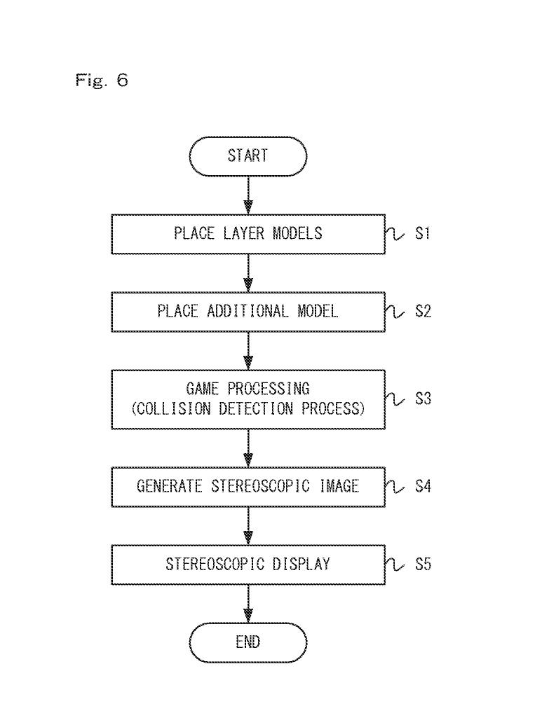

The game program 21 is a program to be executed by the computer of the control section 12. In the exemplary embodiment, information processing described later (FIG. 6) is performed as a result of the control section 12 executing the game program 21. Some or all of the game program 21 is loaded from the program storage section 14 at appropriate timing, is stored in the storage section 13, and is executed by the computer of the control section 12. Alternatively, some or all of the game program 21 may be stored in advance (for example, as a library) in the information processing apparatus having the control section 12.

The processing data 22 is data used in the information processing performed by the control section 12 (FIG. 6). The processing data 22 includes layer model data 23, additional model data 25, texture data 26, and other object data 27.

The layer model data 23 represents layer model information regarding the layer models. The layer model information is information used in the process of placing the layer models in the virtual space. The layer model information may be any information, and may include, for example, some of: information representing the position of each layer model in the virtual space; information representing the positions of the vertices of the polygons forming the layer model; information specifying a texture to be drawn on the layer model; and the like. Further, the layer model data 23 includes reference model data 24 representing the layer model information regarding the reference model 1.

The additional model data 25 represents additional model information regarding the additional model 2 in the virtual space. The additional model information is information used in the process of placing the additional model in the virtual space. The additional model information may be any information, and may include information similar to the layer model information (information representing the position of the additional model, information regarding the vertices of the polygons forming the additional model, information specifying a texture to be drawn on the additional model, and the like).

The texture data 26 represents an image (a texture) representing the three-dimensional display target object. In the exemplary embodiment, the texture data 26 includes data representing the reference model texture to be drawn on the reference model 1, and data representing the additional model texture to be drawn on the additional model 2. It should be noted that data of the reference model texture and the additional model texture may be stored in advance together with the game program 21 in the program storage section 14, so that the data may be read to and stored in the storage section 13 at predetermined timing (at the start of the game processing or the like). Further, data of the original texture may be stored in advance together with the game program 21 in the program storage section 14, so that the data of the reference model texture and the additional model texture may be generated from the original texture at predetermined timing and stored in the storage section 13.

The other object data 27 represents information regarding objects other than the three-dimensional display target object (including the positions of the other objects in the virtual space).

The processing data 22 may include, as well as the above data, correspondence data representing the correspondence between the reference model and the additional model used for the reference model. The correspondence data may indicate, for example, the correspondence between the identification number of the reference model and the identification number of the additional model. In this case, if the position of placing the additional model relative to the reference model is determined in advance, it is possible to specify the placement position of the additional model by referring to the correspondence data. Further, if the reference model texture and the additional model texture may be caused to correspond to each other in advance, it is possible to specify a texture to be used for the additional model, by referring to the correspondence data. Furthermore, the correspondence data may indicate the position of the additional model relative to the reference model. This makes it possible to specify the placement position of the additional model relative to the reference model by referring to the correspondence data.

FIG. 6 is a flow chart showing the flow of the processing performed by the control section 12 in the exemplary embodiment. For example, the CPU of the control section 12 initializes a memory and the like of the storage section 13, and loads the game program from the program storage section 14 into the memory. Then, the CPU starts the execution of the game program 21. The flow chart shown in FIG. 6 is a flow chart showing the processing performed after the above processes are completed.

It should be noted that the processes of all the steps in the flow chart shown in FIG. 6 are merely illustrative. Thus, the processing order of the steps may be changed, or another process may be performed in addition to the processes of all the steps, so long as similar results are obtained. Further, in the exemplary embodiment, descriptions are given on the assumption that the control section 12 (the CPU) performs the processes of all the steps in the flow chart. Alternatively, a processor or a dedicated circuit other than the CPU may perform the processes of some of the steps in the flow chart.

First, in step S1, the control section 12 places the layer models (including the reference model 1) in the virtual space. The reference model 1 and the other layer models are placed, for example, by a method shown in “(4) Placement of Models” described above. The control section 12 stores data representing the positions of the placed layer models as the layer model data 23 in the storage section 13. After step S1, the process of step S2 is performed.

In step S2, the control section 12 places the additional model 2 in the virtual space. The additional model 2 is placed, for example, by a method shown in “(4) Placement of Models” described above. The control section 12 stores data representing the position of the placed additional model 2 as the layer model data 23 in the storage section 13. After step S2, the process of step S3 is performed.

In step S3, the control section 12 performs game processing. The game processing is the process of controlling objects (models) in the virtual space in accordance with the game operation performed on the input section 11 by the user. In the exemplary embodiment, the game processing includes the process of performing collision detection for each object. The collision detection for the three-dimensional display target object is performed, for example, by a method shown in “(6) Collision Detection” described above. In this case, the control section 12 performs the collision detection by reading the reference model data 24 and/or the additional model data 25, and the other object data 27 from the storage section 13. It should be noted that the control section 12 determines the positions of the other objects before the collision detection, and stores data representing the determined positions as the other object data 27 in the storage section 13. Further, after performing the above collision detection, the control section 12 performs processing based on the result of the collision detection. The processing based on the result of the collision detection may be any type of processing, and may be, for example, the process of causing the objects to take some action, or the process of adding points to the score. After step S3, the process of step S4 is performed.

In step S4, the control section 12 generates a stereoscopic image of the virtual space obtained as a result of the game processing performed in step S3. The stereoscopic image (the right-eye image and the left-eye image) is generated, for example, by a method shown in “(5) Generation of Stereoscopic Image” described above. Further, when the stereoscopic image is generated, the process is performed of drawing images of the objects on the models. The drawing process is performed, for example, by methods shown in “(1) Images Drawn on Models” and “(2) Method of Generating Reference Image and Additional Image” described above. It should be noted that, in the exemplary embodiment, the control section 12 reads the texture data 26 prepared in advance from the storage section 13, and performs drawing on the reference model 1 and the additional model 2 using the texture data 26 (more specifically, the data of the reference model texture and the additional model texture included in the texture data 26). After step S4, the process of step S5 is performed.

In step S5, the control section 12 performs stereoscopic display. That is, the stereoscopic image generated by the control section 12 in step S4 is output to the stereoscopic display section 15, and is displayed on the stereoscopic display section 15. This results in presenting the three-dimensional display target in three dimensions to the user.

It should be noted that the processes of the above steps S1 through S5 may be repeatedly performed in a series of processing steps in the control section 12. For example, after the game space is constructed by the processes of steps S1 and S2, the processes of steps S3 through S5 may be repeatedly performed. Alternatively, the processes of steps S1 and S2 may be performed at appropriately timing (for example, in accordance with the satisfaction of a predetermined condition in a game) in the above series of processing steps. This is the end of the description of the processing shown in FIG. 6.

### 3. Variations

In addition, in another embodiment, the technique of displaying an object in three dimensions using the reference model 1 and the additional model 2 can be applied not only to use in a game but also to any information processing system, any information processing apparatus, any information processing program, and any image generation method.

As described above, the exemplary embodiment can be used as a game apparatus, a game program, and the like in order, for example, to present an object in three dimensions.

While some exemplary systems, exemplary methods, exemplary devices, and exemplary apparatuses have been described, it is understood that the appended claims are not limited to the disclosed systems, methods, devices, and apparatuses, and it is needless to say that the disclosed systems, methods, devices, and apparatuses can be improved and modified in various manners without departing the spirit and scope of the appended claims.

What is claimed is:

1. A non-transitory computer-readable storage medium having stored therein a game program executable by a computer of a game apparatus for generating a stereoscopic image for stereoscopic display, the game program causing the computer to execute:
placing at least one plate-like first model in a virtual space, the plate-like first model representing a part of a single object that appears in the virtual space;
placing a plate-like second model in line with and behind the first model, the plate-like second model representing at least a part of the object other than the part represented by the first model; and
generating a stereoscopic image representing the virtual space so as to view the first model and the second model in a superimposed manner from in front of the first and second models.

2. The storage medium according to claim 1, wherein
on a plurality of layers set in line in a front-rear direction in the virtual space, plate-like models are placed such that the second model is one of the plate-like models, and
as the stereoscopic image, an image is generated in which the plate-like models placed on the respective layers and the first model are viewed in a superimposed manner.

3. The storage medium according to claim 2, wherein
the first model is placed between the layer on which the second model is placed and the layer placed immediately in front thereof or immediately therebehind.

4. The storage medium according to claim 1, wherein
on a plurality of layers set in line in a front-rear direction in the virtual space, plate-like models are placed such that the first model is one of the plate-like models; and
as the stereoscopic image, an image is generated in which the plate-like models placed on the respective layers and the second model are viewed in a superimposed manner.

5. The storage medium according to claim 4, wherein
the second model is placed between the layer on which the first model is placed and the layer placed immediately in front thereof or immediately therebehind.

6. The storage medium according to claim 1, wherein
the stereoscopic image is generated so as to include an image representing the first model and the second model in orthogonal projection.

7. The storage medium according to claim 1, wherein
the stereoscopic image is generated in which a direction of a line of sight is generally perpendicular to all the models.

8. The storage medium according to claim 1, wherein
the stereoscopic image is generated such that the part of the object represented by the second model includes an image representing shade.

9. The storage medium according to claim 1, wherein
the stereoscopic image is generated such that an image of the part of the object represented by the first model is an image in which an outline other than an outline of the single object is blurred.

10. The storage medium according to claim 1, wherein
drawing is performed on the first model using a predetermined image representing the single object, and drawing is performed on the second model also using the predetermined image.

11. The storage medium according to claim 1, the game program further causing the computer to execute
performing game processing of performing collision detection between the single object and another object using either one of the first model and the second model.

12. A game apparatus for generating a stereoscopic image for stereoscopic display, the game apparatus comprising:
a first model placement unit for placing at least one plate-like first model in a virtual space, the plate-like first model representing a part of a single object that appears in the virtual space;
a second model placement unit for placing a plate-like second model in line with and behind the first model, the plate-like second model representing at least a part of the object other than the part represented by the first model; and
an image generation unit for generating a stereoscopic image representing the virtual space so as to view the first model and the second model in a superimposed manner from in front of the first and second models.

13. A game system for generating a stereoscopic image for stereoscopic display, the game system comprising:
a first model placement unit for placing at least one plate-like first model in a virtual space, the plate-like first model representing a part of a single object that appears in the virtual space;
a second model placement unit for placing a plate-like second model in line with and behind the first model, the plate-like second model representing at least a part of the object other than the part represented by the first model; and
an image generation unit for generating a stereoscopic image representing the virtual space so as to view the first model and the second model in a superimposed manner from in front of the first and second models.

14. A game image generation method of generating a stereoscopic image for stereoscopic display as a game image, the method comprising:
placing at least one plate-like first model in a virtual space, the plate-like first model representing a part of a single object that appears in the virtual space;
placing a plate-like second model in line with and behind the first model, the plate-like second model representing at least a part of the object other than the part represented by the first model; and
generating as a game image a stereoscopic image representing the virtual space so as to view the first model and the second model in a superimposed manner from in front of the first and second models.
